(19) United States
(12) Patent Application Publication
(10) Pub. No.: US 2015/0343612 A1
(43) Pub. Date: Dec. 3, 2015

(54) Ratchet Handtool

(71) Applicant: Shu-Hui Yeh, Fuxing Township (TW)

(72) Inventors: Chang-Xun Chen, Fuxing Township (TW); Yi-Ju Chen, Fuxing Township (TW)

(21) Appl. No.: 14/538,203

(22) Filed: Nov. 11, 2014

(30) Foreign Application Priority Data
May 30, 2014 (TW) 103119075

(51) Int. Cl. B25B 13/12; B25B 13/46

(52) U.S. Cl. CPC B25B 13/12; B25B 13/46

(57) ABSTRACT

A ratchet handtool includes a main body and a driving head. The main body includes a handle, and a ratchet head disposed at one end of the handle and having an inner surface defining an engaging hole surrounding an axis and an accommodating space spatially communicating with the engaging hole in a longitudinal direction perpendicular to the axis. The driving head is for operating a fastening member, is mounted unmovable relative to the ratchet head along the axis, and is movable in the longitudinal direction between an engaging position, where the driving head engages the engaging hole so as to co-movable with the ratchet head, and an idle position, where the driving head is received in the accommodating space and is idle with respect to the ratchet head.

### CROSS-REFERENCE TO RELATED APPLICATION

This application claims priority of Taiwanese Patent Application No. 103119075, filed on May 30, 2014.

### FIELD OF THE INVENTION

This invention relates to a handtool, more particularly to a ratchet handtool.

### BACKGROUND OF THE INVENTION

Taiwanese patent No. I436862 discloses a conventional ratchet-type handtool including a handle, a driving head and a direction control assembly for switching operating direction of the handle. However, the direction control assembly increases total weight of the conventional ratchet-type handtool.

Referring to FIG. 1, another conventional ratchet-type handtool includes a main body 1 and a driving head 2. The driving head 2 is disposed at one end of the main body 1, and is formed with an engaging hole 103 and an accommodating hole 104 that has a dimension larger than that of the engaging hole 103. To use the conventional ratchet-type handtool of FIG. 1, the main body 1 is first turned in one of clockwise or counter-clockwise directions as the engaging hole 103 directly engages a fastening member (e.g., a screw, a nut, and the like). Next, the engaging hole 103 is brought to disengage from the fastening member, and then, the fastening member is disposed in the accommodating hole 104 so as to turn the main body 1 in the other one of the directions without turning the fastening member. However, such conventional ratchet-type handtool is not compatible with various diameters of fastening members and may be inconvenient for a user.

### SUMMARY OF THE INVENTION

Therefore, the object of the present invention is to provide a ratchet handtool for use with a socket set or a nut set compatible with various diameters of fastening members.

According to this invention, a ratchet handtool includes a main body and a driving head. The main body includes a handle and a ratchet head. The ratchet head is disposed at one end of the handle and has an inner surface. The inner surface of the ratchet head includes a ratchet section that defines an engaging hole surrounding an axis and that is formed with a plurality of engaging portions around the axis, and an accommodating section that defines an accommodating space spatially communicating with the engaging hole in a longitudinal direction perpendicular to the axis. The driving head is mounted to the ratchet head and is unmovable relative to the ratchet head along the axis. The driving head includes a sleeved portion and an operating portion. The sleeved portion includes an outer surface confronting the inner surface of the ratchet head, and a plurality of engaging members disposed at and around the outer surface. The sleeved portion is movable in the longitudinal direction between an engaging position, where the sleeved portion is placed in and engages the engaging hole and the engaging members mesh with the engaging portions so that the sleeved portion is co-movable with the ratchet head, and an idle position, where the sleeved portion is received in the accommodating space and is idle with respect to the ratchet head. The operating portion extends from the sleeve portion for operating a fastening member.

### BRIEF DESCRIPTION OF THE DRAWINGS

Other features and advantages of the present invention will become apparent in the following detailed description of the embodiment of the invention, with reference to the accompanying drawings, in which:

FIG. 1 is a schematic top view of a conventional ratchet handtool;

FIG. 2 is a sectional view of an embodiment of a ratchet handtool according to the present invention;

FIG. 3 is a schematic sectional view taken along line in FIG. 2, illustrating a first driving head of the ratchet handtool disposed at an engaging position and co-movable with a first ratchet head of the ratchet handtool;

FIG. 4 is a schematic sectional view taken along line IV-IV in FIG. 2;

FIG. 5 is a schematic sectional view similar to FIG. 3, where the first driving head is disposed at an idle position and is idle with respect to the first ratchet head;

FIG. 6 is a schematic sectional view taken along line VI-VI in FIG. 2, illustrating a second driving head and a second ratchet head of the ratchet handtool, where the second driving head is disposed at the engaging position; and

FIG. 7 is a schematic sectional view similar to FIG. 6, but illustrating the second driving head being disposed at the idle position.

### DETAILED DESCRIPTION OF THE EMBODIMENT

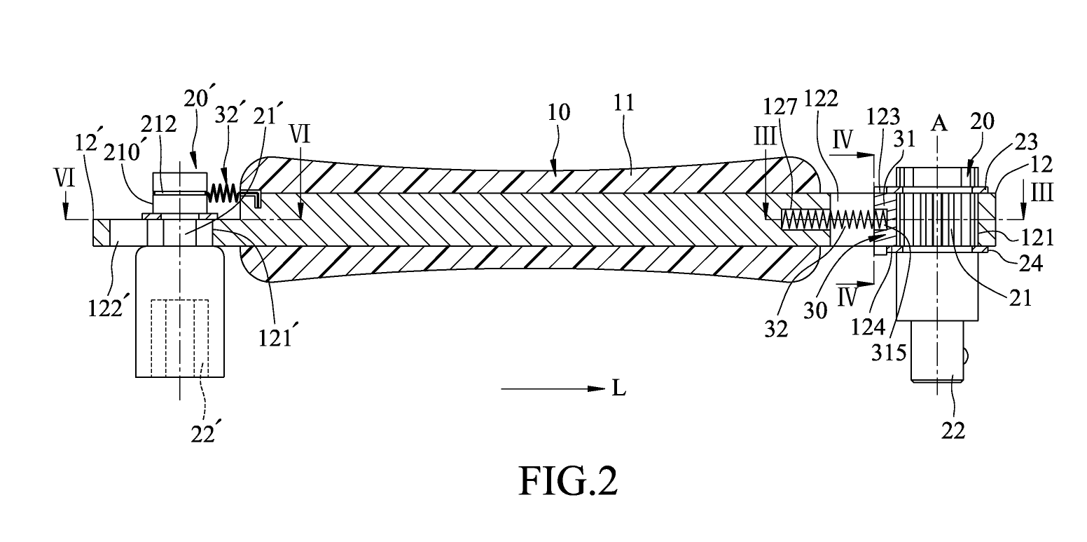

Referring to FIG. 2, the embodiment of the ratchet handtool according to the present invention includes a main body 10, a first driving head 20, a second driving head 20′, a first biasing unit 30 and a second biasing unit 30′.

The main body 10 includes a handle 11, a first ratchet head 12 and a second ratchet head 12′. The first ratchet head 12 is disposed at one end of the handle 11, and the second ratchet head 12′ is disposed at the other end of the handle 11 opposite to the first ratchet head 12 in a longitudinal direction (L) (i.e., an extension direction of the handle 11).

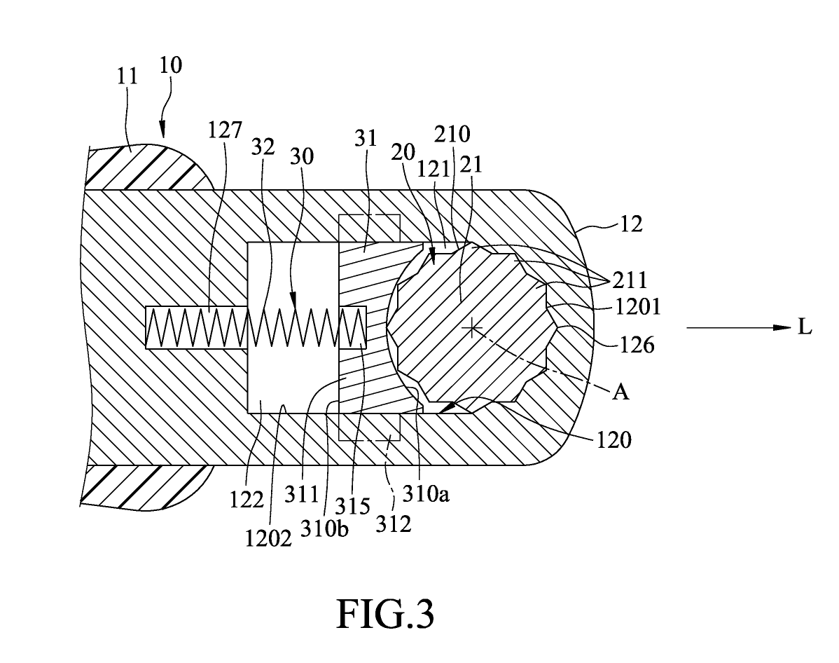

Further referring to FIG. 3, the first ratchet head 12 has an inner surface 120, and first and second surfaces 123, 124. The inner surface 120 of the ratchet head 12 includes a ratchet section 1201 and an accommodating section 1202. The ratchet section 1201 defines an engaging hole 121 surrounding an axis (A), and is formed with a plurality of engaging portions 126 around the axis (A).

The accommodating section 1202 defines an accommodating space 122 spatially communicating with the engaging hole 121 in the longitudinal direction (L) perpendicular to the axis (A), and is disposed between the engaging hole 121 and the handle 11 in the longitudinal direction (L).

The first and second surfaces 123, 124 are opposite to each other along the axis (A), and the engaging hole 121 and the accommodating space 122 extend through the first and second surfaces 123, 124.

The first driving head 20 is mounted to the ratchet head 12, and includes two limiting members 23, 24. The limiting members 23, 24 are disposed respectively at the first and second surfaces 123, 124 of the first ratchet head 12 for limiting movement of the first driving head 20 along the axis (A), and may be C-rings or E-rings.

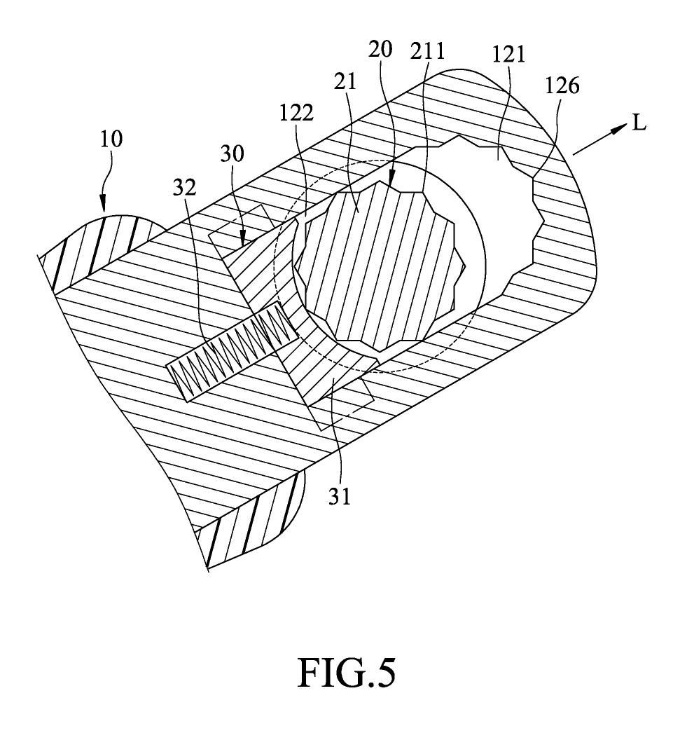

The first driving head 20 includes a sleeved portion 21 and an operating portion 22. The sleeved portion 21 extends beyond the first and second surfaces 123, 124, and includes an outer surface 210 confronting the inner surface 120 of the ratchet head 12, and a plurality of engaging members 211 disposed at and around the outer surface 210. The sleeved portion 21 is movable in the longitudinal direction (L) between an engaging position (FIG. 3), where the sleeved portion 21 is placed in and engages the engaging hole 121 and some of the engaging members 211 mesh with the engaging portions 126 so that the sleeved portion 21 is co-movable with the ratchet head 12, and an idle position (FIG. 5), where the sleeved portion 21 is received in the accommodating space 122 and is idle with respect to the ratchet head 12. Note that, in this embodiment, the engaging portions 126 are V-shaped notches, and the engaging members 211 are V-shaped protrusions so as to mesh with the engaging portions 126.

In this embodiment, the operating portion 22 is a rectangular cylinder extending from the sleeve portion 21 for operating a fastening member, such as a socket of a socket set with various sizes.

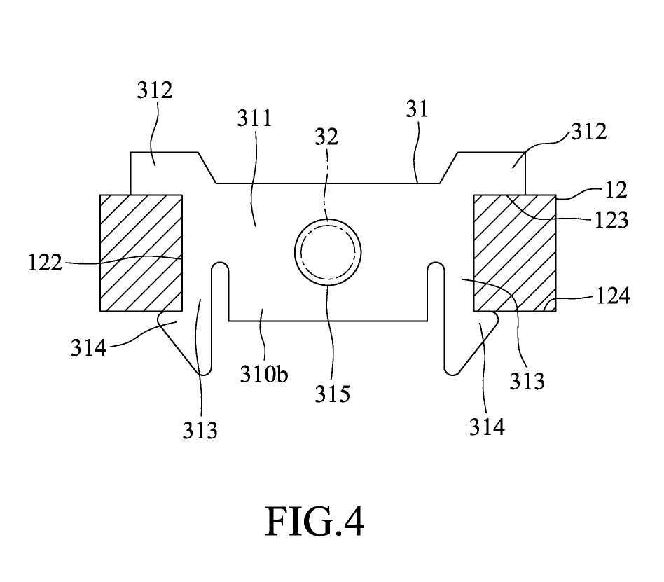

The first biasing unit 30 includes an abutment member 31 and a compression spring 32. The abutment member 31 is disposed slidably in the accommodating space 122, and is movable relative to the first driving head 20 in the longitudinal direction (L). Further referring to FIG. 4, the abutment member 31 includes a block 311, two lateral wings 312, and two resilient strips 313. The block 311 is disposed in the accommodating space 122 and has two opposite sides 310a, 310b. One of the opposite sides 310a abuts against the sleeved portion 21 of the first driving head 20. The lateral wings 312 extend from the block 311 out of the accommodating space 122 opposite to each other, and are disposed in contact with the first surface 123. The resilient strips 313 extend respectively from the lateral wings 312 toward the second surface 124, and have respective hook ends 314 that are resiliently movable relative to the block 311 and that are in contact with the second surface 124 so as to cooperate with the lateral wings 312 to position the block 311 in the accommodating space 122. By pressing the resilient strips 313 toward each other, the hook ends 314 may depart from the second surface 124, such that the block 31 is detachably mounted to the ratchet head 12.

In this embodiment, the other one of the opposite sides 310b of the block 311 is formed with a first blind hole 315, and the handle 11 is formed with a second blind hole 127 aligned with the first blind hole 315 in the longitudinal direction (L). The compression spring 32 has opposite ends respectively inserted into the first blind hole 315 and the second blind hole 127, and provides a biasing force to the abutment member 31 to bias the sleeved portion 21 of the first driving head 20 toward the engaging position shown in FIG. 3.

To loosen or tighten the fastening member, referring to FIG. 3, the operating portion 22 drives the fastening member to co-rotate therewith while the handle 11 rotates about the axis (A) when the sleeved portion 21 is disposed at the engaging position. Hereafter, as shown in FIG. 5, an external force is applied to the main body 10 in the longitudinal direction (L) to counteract the biasing force of the compression spring 32 so as to make the sleeved portion 21 of the first driving head 20 disengage from the engaging hole 121 and be disposed in the accommodating space 122. Then, the handle 11 is rotated relative to the first driving head 20 and the first driving head 20 is idle relative to the first ratchet head 12. That is, the first ratchet head 12 rotates without turning the first driving head 20. Finally, the sleeve portion 21 is biased back to the engaging position by the biasing force of the compression spring 32 after the external force is released. By repeating the ratchet action described above, the fastening member can be easily loosened or tightened.

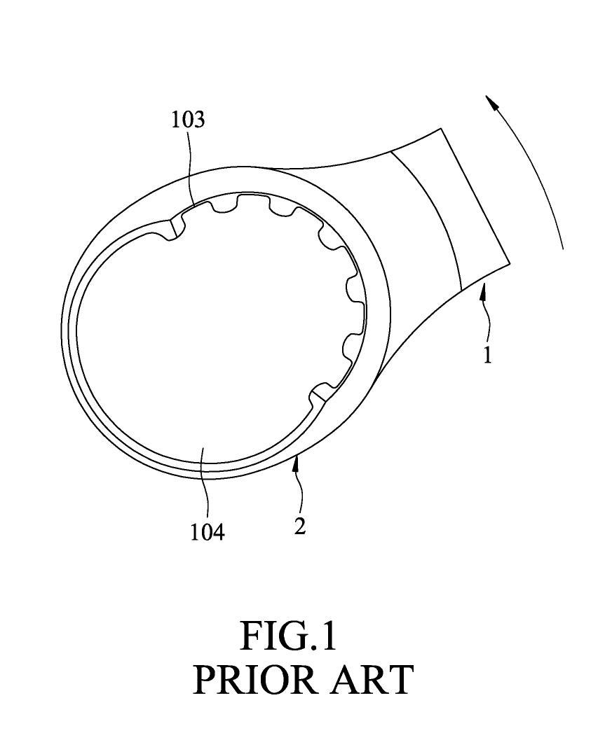

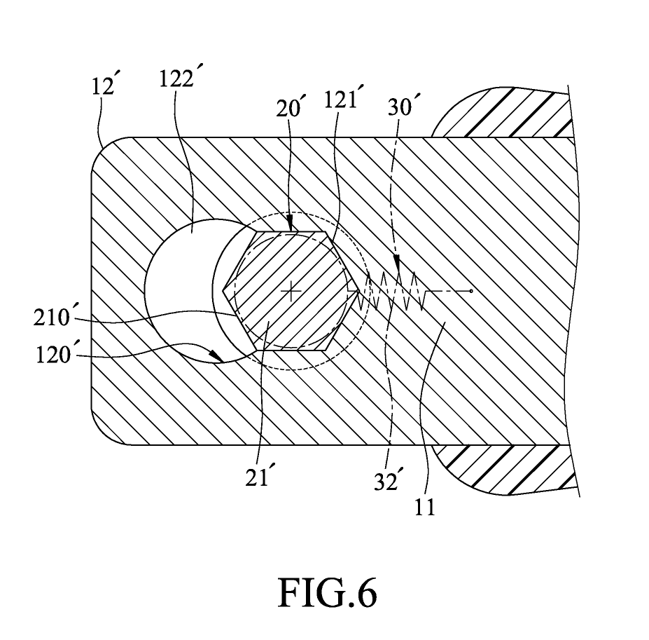

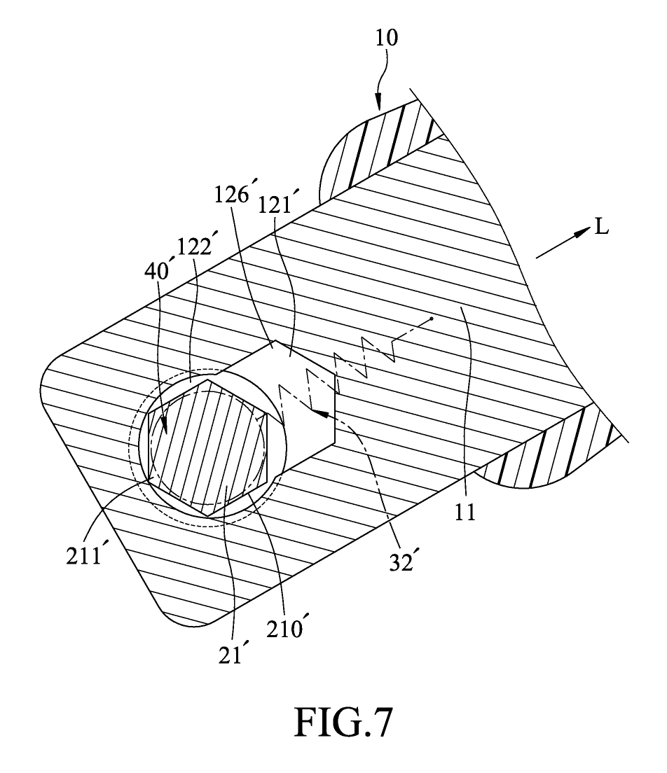

Referring to FIGS. 1, 6 and 7, the second driving head 20′ includes a sleeved portion 21′ and an operation portion 22′. The sleeved portion 21′ is also movable between an engaging position (see FIG. 6) and an idle position (see FIG. 7), and is a hexagonal cylinder having an outer surface 210′ that is formed with a ring groove 212. In particular, six angles of the hexagonal cylinder serve respectively as engaging members 211′ of the sleeved portion 21′. The ring groove 212 surrounds the sleeved portion 21′ at a position that is exposed outwardly of the accommodating space 122′. The second biasing unit 30′ includes an extension spring 32′ having opposite ends that are connected to the handle 11 and the ring groove 212 of the second driving head 20′, respectively. The second ratchet head 12′ has an inner surface 120′ defining an engaging hole 121′ and an accommodating space 122′. The engaging hole 121′ is disposed between the accommodating space 122′ and the handle 11 in the longitudinal direction (L), and has a configuration complementary to the hexagonal sleeved portion 21′ so as to engage therewith. In particular, a section of the inner surface 120′ that defines the engaging hole 121′ is formed with a plurality of notches serving respectively as engaging portions 126′ for meshing with the engaging members 211′. Additionally, the operating portion 22′ is a hexagonal socket for operating a fastening member such as a nut of a nut set with various sizes.

To sum up, the advantages of the ratchet handtool of the present invention are as follows. In the present invention, by virtue of the first/second driving head 20/20′ together with the first/second ratchet head 12/12′, the ratchet handtool can operate the fastening member in both directions (i.e., loosen and tighten) without using a direction control assembly as described in Taiwanese patent No. I436862. Further, the driving head 20 that is mounted unmovable relative to the ratchet head 12 along the axis (A) can be attached to a fastening member of a socket set or a nut set, and is thus compatible with various fastening members having different sizes.

Finally, the first/second biasing unit 30/30′ that restores the sleeved portion 21 of the first/second driving head 20/20′ to the engaging position enables the sleeved portion 21/21′ to stably engage the engaging hole 121/121′, thus preventing damage of the engaging portions 126/126′ during the ratchet action of the ratchet handtool so as to prolong the service life of the ratchet handtool according to the present invention.

While the present invention has been described in connection with what is considered the most practical embodiment, it is understood that this invention is not limited to the disclosed embodiment but is intended to cover various arrangements included within the spirit and scope of the broadest interpretations and equivalent arrangements.

What is claimed is:

1. A ratchet handtool comprising:
a main body including
a handle, and
a ratchet head that is disposed at one end of said handle and that has an inner surface, said inner surface including a ratchet section that defines an engaging hole surrounding an axis and that is formed with a plurality of engaging portions around the axis, and an accommodating section that defines an accommodating space spatially communicating with said engaging hole in a longitudinal direction perpendicular to the axis; and
a driving head mounted to said ratchet head, being unmovable relative to said ratchet head along the axis, and including
a sleeved portion that includes an outer surface confronting said inner surface of said ratchet head, and a plurality of engaging members disposed at and around said outer surface, said sleeved portion being movable in the longitudinal direction between an engaging position, where said sleeved portion is placed in and engages said engaging hole and said engaging members mesh with said engaging portions so that said sleeved portion is co-movable with said ratchet head, and an idle position, where said sleeved portion is received in said accommodating space and is idle with respect to said ratchet head, and
an operating portion that extends from said sleeve portion for operating a fastening member.

2. The ratchet handtool as claimed in claim 1, wherein said ratchet head further has first and second surfaces which are opposite to each other along the axis, and through which said engaging hole and said accommodating space extend, said sleeved portion of said driving head extends beyond said first and second surfaces, and said driving head further includes at least one limiting member disposed at one of said first and second surfaces for limiting movement of said sleeved portion along the axis.

3. The ratchet handtool as claimed in claim 1 further comprising a bias ing unit for biasing said sleeved portion of said driving head toward the engaging position.

4. The ratchet handtool as claimed in claim 3, wherein said biasing unit includes:
an abutment member disposed slidably in said accommodating space, being movable relative to said driving head in the longitudinal direction, and having two opposite sides, one of which abuts against said sleeved portion; and
a compression spring having opposite ends connected to the other one of said opposite sides of said abutment element and said handle, respectively.

5. The ratchet handtool as claimed in claim 4, wherein:
said ratchet head further has first and second surfaces which are opposite to each other along the axis, and through which said engaging hole and said accommodating space extend; and
said abutment member includes
a block disposed in said accommodating space,
two lateral wings extending from said block out of said accommodating space, opposite to each other, and disposed in contact with said first surface, and
two resilient strips extending respectively from said lateral wings toward said second surface, and having respective hook ends that are resiliently movable relative to said block and that are in contact with said second surface so as to cooperate with said lateral wings to position said block in said accommodating space.

6. The ratchet handtool as claimed in claim 4, wherein said accommodating space is disposed between said engaging hole and said handle in the longitudinal direction.

7. The ratchet handtool as claimed in claim 3, wherein said engaging hole is disposed between said accommodating space and said handle in the longitudinal direction.

8. The ratchet handtool as claimed in claim 7, wherein said biasing unit is an extension spring having opposite ends that are connected to said handle and said sleeved portion of said driving head, respectively.
